(19) United States
(12) Patent Application Publication
(10) Pub. No.: US 2011/0151740 A1
(43) Pub. Date: Jun. 23, 2011

(54) WRAPPER FOR REFRIGERATING MATERIAL AND REFRIGERATING DEVICE USING THIS WRAPPER

(75) Inventor: Francois Ducrocq, Jouars-Pontchartrain (FR)

(73) Assignee: LISOTHERME, Montigny Le Bretonneux (FR)

(21) Appl. No.: 12/997,111

(22) PCT Filed: Jun. 5, 2009
(86) PCT No.: PCT/FR2009/051061

§ 371 Date: Mar. 3, 2011

(30) Foreign Application Priority Data
Jun. 9, 2008 (FR) 0853803

(51) Int. Cl. D04H 13/00; B32B 27/00; B32B 15/08

(52) U.S. Cl. 442/414; 428/476.3; 428/461

(57) ABSTRACT

The invention relates to a wrapper (3) for refrigerating material (2) and to refrigeration energy storage devices (1) using such a wrapper, particularly suitable for transporting parcels (5), the temperature of which it is desired to keep constant, or for being applied to the body of a human or animal and provide a dry cooling sensation. The outer surface of the wrapper is formed by a layer that absorbs moisture, particularly condensation. This layer is typically a non-woven fabric.

The present invention relates to a wrapper for refrigerant material. The present invention also relates to coolant energy storage devices using such a wrapper.

The use of such refrigeration energy storage devices is known for keeping items such as fresh products, medicines, electronic products, biological specimens, etc. at a given temperature for a determined duration. Maintaining a constant temperature is carried out by bringing together the products to be preserved and the refrigeration energy storage device(s) in which a refrigerant material has been placed, within a package which is preferably isothermal. In this way a package is formed in which the sensitive products are kept at a controlled temperature for a duration at least equal to that provided for transportation.

Such devices can also be used for cooling the body of a human or animal and for pain relief.

The refrigerant material used for the device is subjected before use to a reversible transformation such as solidification. The subsequent reverse transformation of the refrigerant material will absorb calories and thus retain a temperature very close to the eutectic point for the entire duration of the transformation.

According to a known implementation, the coolant energy storage device is a flexible wrapper made of plastic material in which a refrigerant material is inserted, in particular a eutectic gel.

Patent GB 2318633 A describes a portable cooling pouch used for the preservation of items and constituted by a material that is impermeable to water. The pouch defines compartments in which water-absorbent granules are located. When the pouch is immersed in water, the granules form a gel capable of retaining the temperature of the water for a certain period of time. The compartmentalized pouch is rolled around the product to be kept cool.

Patent GB 2383539 A describes a cooling device comprising particles of absorbent polymer contained in a

wrapper. The particles are constituted by a water-absorbent core and a covering that retains water, the latter being desorbed in the gaseous state if sufficient heat is stored. The wrapper comprises one side that conducts heat and is impermeable to water, and one side that is permeable to water. The device is immersed in water, which when evaporating will result in the desired cooling. The water can only evaporate through the side of the wrapper that is permeable to water. The other side of the wrapper then makes it possible to provide a “dry cold” sensation.

In these two examples, the water-absorbent particles only make it possible to retain the moisture during immersion in water of the coolant energy storage device. The water then acts as a refrigerant material.

A drawback of the devices known to date is that the cold maintained by the thawing of the refrigerant material generates condensation on the outer face of the wrapper. This condensation can degrade a product that is to be kept cool. It is unpleasant or even detrimental in applications.

The idea on which the present invention is based is to limit the negative effect of the condensation formed, by absorbing this condensation. According to the invention, the wrapper for refrigerant material, in particular a eutectic gel, is characterized in that its outer surface is formed by a moisture-absorbent layer. Thus, the outer surface of the wrapper remains substantially dry, as the moisture from condensation is absorbed by the moisture-absorbent layer.

Another advantage is that the device is then a “dry cooling” device on all its surfaces. This “dry cooling” sensation contributes to the comfort of use for uses of the device on the human or animal body. For cooling packages, the products contained in the packages are no longer impregnated with water from condensation.

Moreover, when comparing the performance of the coolant energy storage device according to the present invention with those of a coolant energy storage device without a moisture-absorbent covering, the following two surprising phenomena are observed:
Return to the eutectic point of the refrigerant material placed within the coolant energy storage device is more rapid. There is a saving in time of at least 34% in a specific example.
The performance of the coolant energy storage device containing said refrigerant material at the desired temperature is sustained for longer. There is a gain in time of at least 19% in a specific example.

Thus, surprisingly, the wrapper according to the invention increases the duration and quality of the cooling effect obtained. This appears to be due to the thermal conductivity of the wrapper according to the invention, which because of the covering is lower than that of known wrappers. Based on this observation, it was proved possible to further extend the cooling effect obtained by using a refrigerant material the eutectic point of which is slightly lower (for example 1° C. lower) than the desired temperature which exists outside the device.

The refrigerant material is chosen by a person skilled in the art using his habitual knowledge according to the application and in particular, the desired stable temperature.

Preferably, the wrapper is formed by laminating a plastic film and a covering constituting the moisture-absorbent layer. In an embodiment, the plastic film is formed successively from a layer of polyethylene, binder between the polyethylene layer and a polyamide layer, the polyamide layer, and binder between the polyamide layer and the moisture-absorbent covering. The thickness of the plastic film is of the order of 90 μm.

The laminate obtained from the moisture-absorbent covering and the plastic film is welded in the form of a sachet then filled with refrigerant material. An example of lamination of the covering with plastic film is produced by OuestPack, situated in Perros Guirec (22). An example of welding is carried out by Innovapac, situated in Durach/Allgäu, Germany. In this case, sachets with three welds are involved.

The moisture-absorbent covering is preferably a non-woven fabric, preferably of crossed web fabric for greater resistance in particular to impact and falls. This non-woven fabric covering is preferably formed by mixtures of polyester, viscose, acrylic, or pure viscose fibres, or viscose/polyester composites.

The moisture-absorbent layer can be of different thicknesses. For a thickness varying between 300 and 400 μm, it typically absorbs between 15 and 20 g water per sachet. For a thickness varying between 400 and 500 μm, it typically absorbs between 20 and 30 g water per sachet. Typically, for a thickness of 420 μm, the moisture-absorbent layer absorbs between 400 and 500 g water per m² of moisture-absorbent layer.

The total thickness of the wrapper can be at least equal to 500 μm.

The wrapper can be used to produce a refrigerant pouch intended to be inserted in a package the temperature of which it is desired to maintain and in order to produce a cooling pouch intended to be applied to the human or animal body, in particular for paramedical purposes.

Thanks to the invention, the wrapper of the device is made more shock-resistant than the known devices. The invention dispenses with the use of moisture-absorbers in the package, which would increase the weight of the package.

Other features and advantages of the invention will become apparent on reading the detailed description of an embodiment that is in no way limitative, and the attached drawings, in which:

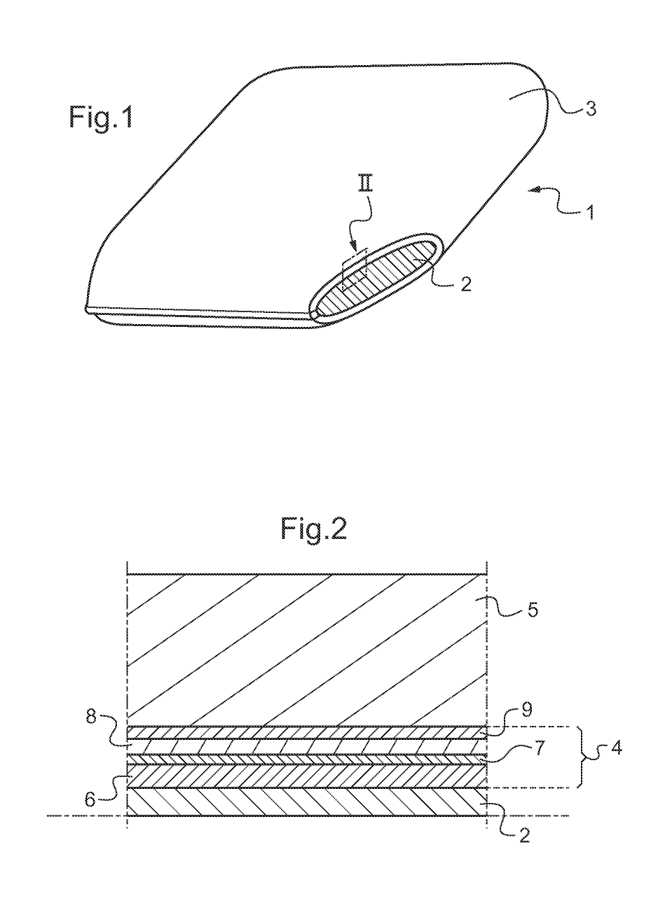

FIG. 1 is a perspective overview of a device according to the invention, with cutaway;

FIG. 2 is an enlarged cross-section of the detail II of FIG. 1, showing the different layers of a wrapper according to the invention;

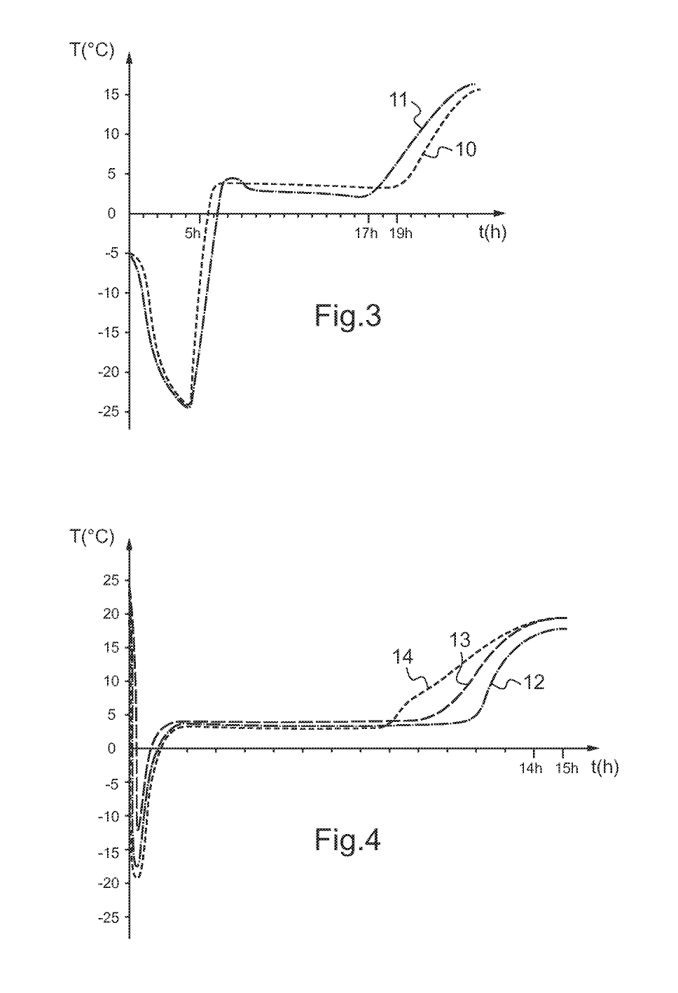

FIG. 3 shows the evolution over time of the temperature of a device according to the invention and of a device according to the state of the prior art; and

FIG. 4 shows the evolution over time of the temperature of a dry device according to the invention and of a wet device according to the invention, and of a dry device according to the state of the prior art.

The invention will now be described with reference to FIGS. 1 to 4.

The device 1 according to the invention is constituted by a refrigerant material 2, in particular a eutectic gel, and a wrapper 3. The wrapper 3 completely covers the refrigerant material 2 and encloses it so that it is watertight. During use, the device 1 is subjected to a temperature sufficiently low for the refrigerant material 2 to undergo a reversible transformation, for example solidification. The device is then placed close to products to be refrigerated, in particular in order to be maintained at a temperature below ambient temperature. In general, the device(s) and the products are housed in packaging provided with thermal insulation. The reverse transformation (softening or liquefaction) of the refrigerant material 2 is endothermic and thus makes it possible to maintain the device(s) 1 and the products at a temperature very close to the eutectic point for the entire duration of the transformation.

The wrapper 3 is formed by laminating a plastic film 4 and an outer covering 5 for absorbing the moisture. In order to produce a device 1 starting from a laminated sheet, it is folded in two, the joining edges on two opposite sides, situated at each side of the fold, are welded, the open sachet formed in this way is filled with refrigerant material 2, then the edge opposite to the fold is welded in order to obtain a hermetically sealed wrapper 3 having a generally rectangular shape, one folded edge and three welded edges.

The plastic film 4 is formed from
an inner polyethylene layer 6 which allows the edges of the wrapper 3 to be welded;
a polyamide layer 8 which provides the watertightness of the wrapper 3 and which is placed on the outer side with respect to the inner layer 6;
a binder layer 7 which binds the polyethylene layer 6 to the polyamide layer 8;
a binder layer 9 which binds the polyamide layer 8 and the covering 5.

In another method of producing the film, an aluminized plastic sheet is used that is constituted for example by a layer of polyethylene terephtalate (PET) on the covering side, a layer of polyethylene (PE) on the inner side, and an aluminium film between these two layers. The aluminium film forms a thermal barrier which further reduces the thermal conductivity of the wrapper.

In either embodiment according to the invention, the thickness of the plastic film 4 is of the order of 90 μm.

The covering 5 defines the outer face of the wrapper. It is preferably produced from a non-woven fabric. This non-woven fabric is preferably from crossed web fabric for greater resistance to impact and falls. By “crossed web non-woven fabric” is meant a non-woven fabric produced with fibre webs in which the fibres have one predominant orientation, and which are superimposed so that the predominant orientations of the adjacent webs are different. The webs thus superimposed are bonded together by known mechanical, thermal, chemical techniques, etc. The non-woven covering 5 is preferably formed from a mixture of polyester, viscose, acrylic fibres. It can also, for example, be constituted only by pure viscose fibres, or viscose/polyester composite fibres. The fibres are preferably bonded by a cross-linked resin representing for example 30% of the weight of the non-woven fabric. An example of such a non-woven fabric is marketed by Intissel, from the Chargeurs group, situated in Wattrelos (59).

The covering 5 can have various thicknesses. For a thickness comprised between 300 and 400 μm, it typically absorbs between 15 and 20 g water per sachet. For a thickness comprised between 400 and 500 μm, it typically absorbs between 20 and 30 g water per sachet or more. Typically, for a thickness of 420 μm, the covering absorbs between 400 and 500 g water per m² of its surface area.

In an embodiment of the invention, the total thickness of the wrapper 3 can be of the order of 500 μm or more.

In service, condensation tends to form on the outer surface of the device 1 and on the goods maintained by the device 1 at a temperature below ambient temperature. This condensation originating from the moisture in the ambient air can degrade the products to be kept cool or impregnate the packages with water. The covering 5 according to the invention absorbs the water thus condensed and thus allows the above-mentioned drawbacks to be overcome. The device 1, the products and the walls of the packaging forming the package remain substantially dry.

In a further embodiment, the device 1 can be applied to the human or animal body, in particular for paramedical purposes. More specifically, the device is placed in the refrigerator, and in particular in the freezer, for a sufficient length of time for the refrigerant material 2 to solidify, then it is applied to an area of the human or animal body, for example to relieve inflammation, migraine, muscular pain, to cool the body during or after sports exercise, etc. Thanks to the covering 5, the device 1 remains dry and provides a “dry cooling” sensation which contributes to the comfort of use of the device 1.

FIG. 3 shows the evolution over time of the temperature of the device 1 and of a device according to the state of the prior art. The two devices containing the same quantity of an identical refrigerant material were firstly cooled, then allowed to return to an ambient temperature higher than the temperature of liquefaction of the refrigerant material. The respective temperatures of the two devices are measured at their surfaces throughout the entire duration of the experiment, from the start of the cooling phase, until the temperatures of the devices have almost reached ambient temperature. The temperature is expressed in degrees Celsius, and the timescale is graduated in hours. The curve 10 corresponds to the device 1 according to the invention. The curve 11 corresponds to the device according to the state of the prior art. Four main stages are distinguished:
a stage of cooling from approximately 0 h to 5 h;
a stage of returning to the eutectic point, from approximately 5 h to approximately 7 h;
a stage at an almost constant temperature, from approximately 7 h to approximately 17 h for the device according to the state of the prior art, respectively up to approximately 19 h for the device 1;
a stage of returning to ambient temperature, from approximately 17 h for the device according to the state of the prior art, respectively from approximately 19 h for the device 1;

These durations are given by way of indication only, and can vary substantially according to the protocol of the experiment (dimensions of the wrapper, mass and nature of the refrigerant material, environmental conditions, etc.).

The cooling stage corresponds to the phase of cooling the refrigerant material of the two devices to a temperature below the solidification point of their refrigerant material.

The stage of returning to the eutectic point corresponds to stopping the cooling of the devices.

The stage of almost constant temperature corresponds to the stage of reverse transformation of the refrigerant material which allows the devices to be maintained at a temperature very close to the eutectic point. It is apparent that the temperature outside the device according to the invention is a little above that of the device according to the state of the art during the eutectic reaction.

The start of the stage of return to ambient temperature corresponds to the end of this reverse transformation.

FIG. 3 demonstrates the two surprising phenomena below:
the curve 10 of the temperature of the device 1 reaches the eutectic point before the temperature curve of the device according to the prior art 11;
the third stage (maintaining at eutectic temperature) begins earlier and has a longer duration with the device 1 according to the invention than with the device according to the prior art.

With respect to the duration necessary to reach the eutectic point, the gain when passing from the device according to the prior art to the device 1 is of at least 34% in a specific example.

With respect to maintaining the desired temperature, this gain is at least 19% in a specific example.

In FIG. 4, the curve 12 shows the evolution over time of the temperature of a wet device 1 according to the invention, the curve 13 that of the dry device 1, and the curve 14 that of a dry device according to the state of the prior art. The three devices were firstly cooled, then allowed to return to ambient temperature as in the experiment described with reference to FIG. 3. The respective temperatures of the three devices were measured at their surfaces during the entire duration of the experiment, from the start of the cooling phase until the temperatures of the devices had almost reached ambient temperature. The temperature is expressed in degrees Celsius, and the timescale is graduated in hours.

Again, four main stages are distinguished:
a stage of cooling from approximately 0 h to 30 min;
a stage of returning to the eutectic point, from approximately 30 min to approximately 1 h;
a stage at an almost constant temperature, from approximately 1 h to approximately 9 h for the dry device according to the state of the prior art, respectively approximately 10 h 30 min for the dry device 1 and approximately 12 h for the wet device 1;
a stage of returning to ambient temperature, from approximately 9 h for the device according to the state of the prior art, respectively from approximately 10 h 30 min for the dry device 1 and from approximately 12 h for the wet device 1, up to approximately 15 h.

The cooling stage corresponds to the phase of cooling the refrigerant material of the three devices to below the freezing point.

The stage of returning to the eutectic point corresponds to stopping the cooling of the devices, and to their contact with an ambient atmosphere.

The stage of almost constant temperature corresponds to the stage of reverse transformation of the refrigerant material which allows the devices to be maintained at a temperature very close to the eutectic point.

The stage of return to ambient temperature begins at the end of this reverse transformation. Again, it is apparent that the temperature outside the device according to the invention is a little above that of the device according to the state of the art during the eutectic reaction.

FIG. 4 moreover demonstrates the following surprising phenomenon:

the temperature curve 12 of the wet device 1 is maintained longer at the desired temperature than that of the temperature curve 13 of the dry device 1.

Of course, the two phenomena previously stated with reference to FIG. 3 are still present. It is therefore also apparent that:
the curves 12, respectively 13, of the temperature of the wet, respectively dry, device 1 reach the eutectic point before the temperature curve 14 of the device according to the prior art;
the curves 12, respectively 13, of the temperature of the wet, respectively dry, device 1 is maintained longer at the desired temperature than that of the temperature curve 14 of the device according to the prior art.

In these two experiments, the device according to the prior art is a “PAPE” device i.e. the wrapper of which is constituted by polyamide and polyethylene.

Of course, the invention is not limited to the examples which have just been described, and numerous adjustments can be made to these examples without exceeding the scope of the invention. In particular, numerous variations can be envisaged as to the shape of the wrapper 3 and the composition of the plastic film 4.

In order to produce the device, the technique of vertical bagging, known per se can be used: a strip of wrapping material, thus within the context of the invention the laminate covering-film, moves upwards, the strip is folded back on itself about its longitudinal axis, and a tube is formed by welding together the two edges of the strip; successive transverse welds are formed which subdivide the tube into pouches; before each transverse weld, the still-open pouch is filled with the desired material, here the refrigerant material; the pouches formed are separated by a cutting operation.

In a further embodiment, the starting point is two superimposed sheets of laminate that are welded on three sides, or more generally on one portion of their perimeter, in order to form a pouch that is filled with refrigerant material before welding the fourth side, or more generally the remainder of the perimeter.

Many other configurations of plastic films can be combined with the non-woven fabric covering. Thus, a laminate can be used having an oriented polyamide film (OPA) situated on the covering side, and polyethylene (PE) on the inner side, or a polyethylene terephtalate (PET) film situated on the covering side, and polyethylene (PE) on the inner side, or an oriented polypropylene (OPP) film situated on the covering side, and polyethylene (PE) on the inner side, etc.

For particular applications, the moisture-absorbent covering could cover only a portion of the outer face of the wrapper, for example only one of two opposite outer faces.

1- Wrapper for refrigerating material (2), in particular eutectic gel, characterized in that its outer surface is formed by a moisture-absorbent layer (5).

2- Wrapper according to claim 1, characterized in that it is formed by laminating a plastic film (4) and a covering (5) constituting the moisture-absorbent layer.

3- Wrapper according to claim 2, characterized in that the film and/or the covering has a property of reducing the thermal conductivity of the wrapper.

4- Wrapper according to claim 2, characterized in that the plastic film (4) is formed successively from a layer of polyethylene (6), binder (7) between the polyethylene layer and a polyamide layer, the layer of polyamide (8) and binder (9) between the polyamide layer and the moisture-absorbent covering (5).

5- Wrapper according to claim 2, characterized in that the plastic film (4) is successively formed from a layer of polyethylene terephtalate (PET) on the covering side (5), an aluminium film, and a layer of polyethylene (PE) on the inner side.

6- Wrapper according to claim 2, characterized in that the laminate obtained from the moisture-absorbent covering (5) and the plastic film (4) is welded in the form of an open sachet, filled with refrigerant material (2), then hermetically sealed closed by welding.

7- Wrapper according to claim 2, characterized in that the moisture-absorbent covering (5) is a non-woven fabric.

8- Wrapper according to claim 7, characterized in that the non-woven fabric is of the type formed from crossed web fabrics.

9- Wrapper according to claim 8, characterized in that the non-woven fabric covering (5) is formed from fibres chosen from pure viscose, a mixture of polyester, viscose, acrylic, or viscose/polyester composite fibres.

10- Wrapper according to claim 1, characterized in that the moisture-absorbent layer (5) has a thickness comprised between 400 and 500 μm and allows at least 450 g water to be absorbed per m² of moisture-absorbent layer.

11- Wrapper according to claim 1, characterized in that its wall has a total thickness at least equal to approximately 500 μm.

12- Coolant energy storage device intended to be inserted into a package of which it is desired to maintain the temperature, comprising a wrapper according to claim 1 containing a eutectic substance.

13- Cooling device intended to be applied to the human or animal body, in particular for paramedical purposes, comprising a wrapper according to claim 1 containing a eutectic substance.

14. Wrapper according to claim 3, characterized in that the plastic film (4) is formed successively from a layer of polyethylene (6), binder (7) between the polyethylene layer and a polyamide layer, the layer of polyamide (8) and binder (9) between the polyamide layer and the moisture-absorbent covering (5).

15. Wrapper according to claim 3, characterized in that the plastic film (4) is successively formed from a layer of polyethylene terephtalate (PET) on the covering side (5), an aluminium film, and a layer of polyethylene (PE) on the inner side.
